(19) United States
(12) Patent Application Publication
(10) Pub. No.: US 2007/0255616 A1
(43) Pub. Date: Nov. 1, 2007

(54) Techniques for authoring ads for dynamic layout environments

(75) Inventors: Kevin B. Gjerstad, Kirkland, WA (US); Filipe Fortes, Pittsburgh, PA (US); Michael S. Cooper, Mercer Island, WA (US); Jeffrey J. Maurone, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/413,407

(22) Filed: Apr. 27, 2006

(51) Int. Cl. G06Q 30/00

(52) U.S. Cl. 705/14

(57) ABSTRACT

An electronic advertisement includes an ad layout that defines at least one element, the element referring to media content for the electronic advertisement. The media content including text in vector format, a border that is scalable without loss in fidelity, and logic that enables swapping an image based on a change in display characteristics of the electronic advertisement.

### BACKGROUND

1. Technical Field

The present invention relates to the field of electronic advertising. More particularly, the present invention relates to authoring an electronic advertisement for display in a dynamic layout environment.

2. Description of Related Art

Finding information has never been easier since the advent of the Internet. Today very many people open their browsers every time a question comes to mind, or any time they just want to know what's new. People go online to shop for new cars, books, toys, computers, gadgets of all kinds, even services, like medical and legal services. For many, the online world has become the first place to look for any worthwhile information. The Internet has become so comfortable that many choose even to pass time playing or relaxing online. There are countless web sites that offer information on every conceivable topic.

Naturally, with this level of interest, many enterprising companies and individuals are seeking ways to commercialize the online world. One common method is a new application of an age-old technique—advertising. Many companies have taken to adding online advertising to their ordinary and conventional advertising programs. The owners and operators of many web sites make their information freely available while charging their customers to advertise on their web sites. Online advertising had its early skeptics, but is now widely accepted as a realistic business model. And as with all business models, those competing in it are trying to distinguish themselves.

Online advertising has some interesting advantages over conventional advertising because of its electronic nature. For instance, when a visitor arrives at a web site online, there is information made available to the web site about that visitor, such as perhaps the type of browsing software or operating system being used. Cookies often provide the web site with interesting information about the visitor too. In addition, web sites today are often dynamically generated with content and advertisements when a page is requested. In this way, each visitor to a web site can enjoy an almost personal experience. However, conventional technology is generally limited in terms of laying out advertisements in dynamic layout environments.

Better techniques for online advertising are a never ending quest for those skilled in the art.

### SUMMARY

Briefly stated, an electronic advertisement includes an ad layout that defines at least one element, the element referring to media content for the electronic advertisement. The media content including text in vector format, a border that is scalable without loss in fidelity, and/or logic for swapping an image based on a change in display characteristics of the electronic advertisement.

### BRIEF DESCRIPTION OF THE DRAWINGS

Many of the attendant advantages of this invention will become more readily appreciated as the same becomes better understood by reference to the following detailed description, when taken in conjunction with the accompanying drawings, briefly described here.

FIG. 1 is a functional block diagram of an exemplary computing device that may be used to implement one or more embodiments of the invention.

FIG. 2 is a functional block diagram of an advertisement authoring system for creating electronic advertisements (“ads”) that are particularly well suited for use in a dynamic layout environment.

FIG. 3 is a graphical representation of one example of an ad authored in accordance with layout rules, such as those introduced above in conjunction with FIG. 2.

FIGS. 4 and 5 are graphical representations of a display in which media content is being displayed.

FIGS. 6 and 7 are graphical representations of another display in which media content is being displayed.

FIGS. 8 and 9 are graphical representations of yet another display in which media content is being displayed.

The invention will now be described in detail with reference to these Figures wherein like numerals refer to like elements throughout.

### DETAILED DESCRIPTION OF EMBODIMENTS OF THE INVENTION

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Briefly stated, embodiments include techniques for authoring electronic advertisements (“ads”) that enable the ads to tolerate disfigurement without substantial loss of fidelity. Embodiments of the invention will be now described first with reference to an illustrative computing environment in which the embodiments may be implemented, next with reference to graphical representations of ads authored in accordance with these embodiments, and finally with reference to certain processes or methods that may be used to implement embodiments of the invention.

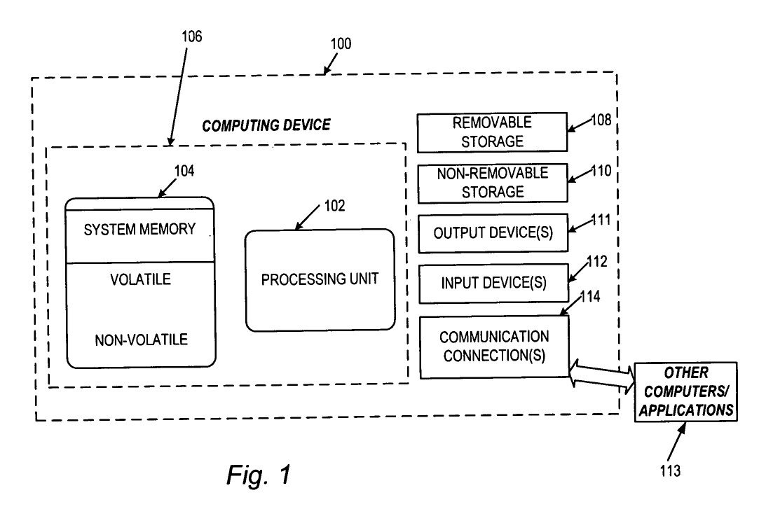

FIG. 1 is a functional block diagram of an exemplary computing device 100 that may be used to implement one or more embodiments of the invention, such as the embodiments described below. The computing device 100, in one basic configuration, includes at least a processing unit 102 and memory 104. Depending on the exact configuration and type of computing device, memory 104 may be volatile (such as RAM), non-volatile (such as ROM, flash memory, etc.) or some combination of the two. This basic configuration is illustrated in FIG. 1 by dashed line 106.

Additionally, device 100 may also have other features and functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with one or more computers and/or applications 113. Device 100 may also have input device(s) 112 such as keyboard, mouse, pen, voice input device, touch input device, etc. Output device(s) 111 such as a monitor, speakers, printer, PDA, mobile phone, and other types of digital display devices may also be included. These devices are well known in the art and need not be discussed at length here.

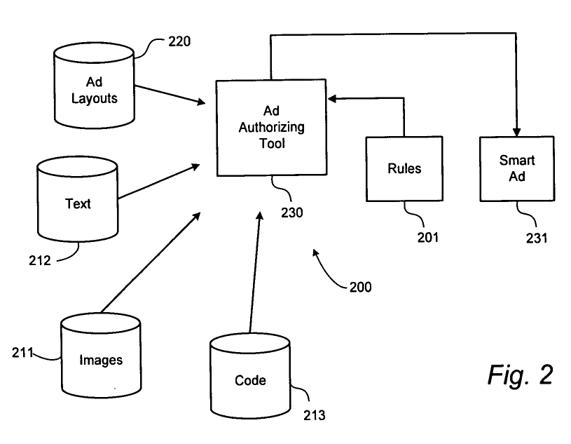

FIG. 2 is a functional block diagram of an advertisement authoring system 200 for creating electronic advertisements (“ads”) that are particularly well suited for use in a dynamic layout environment. In this implementation, the system 200 includes an image store 211, a text store 212, and a code store 213. These three data storage components contain the media content that forms the substance of one or more ads. For example, an ad for computer products may include images, such as an image of a sample product and a company logo. The ad may also include text, such as contact information, product features, tag lines, and the like. The ad may also include code, such as markup instructions, executable code, media scripting instructions, or the like. One specific example of the type of code that may be used to create an ad is the ActionScript language used for scripting Macromedia “Flash” documents, such as movies and applications.

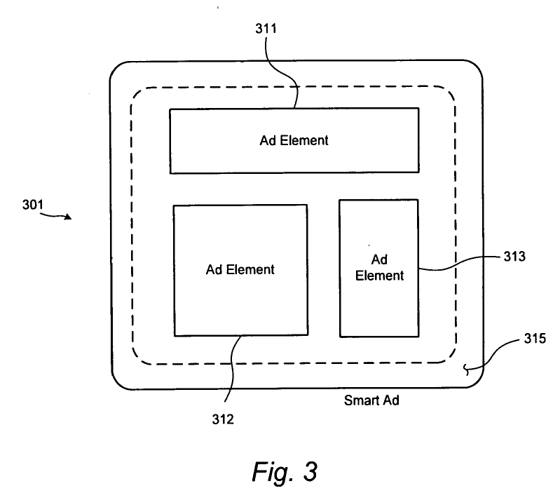

Another data store, an ad layout store 220, includes instructions or code that define an ad or an ad layout. In this implementation, an ad layout may take the form of a markup based document that specifies each constituent element of an ad. Each element description may refer to the media content that makes up the ad. For example, an ad layout may define several ad elements, which in turn each refer to an image or text of the ad. The ad layout is described in greater detail below with reference to an example ad illustrated in FIG. 3.

Authoring rules 201 are provided by the system 200 and include instructions or governing principles that are to be applied when constructing an ad, in accordance with this implementation of the invention. The rules 201 are defined to control the structure and format of certain elements so that an ad created using the elements will be particularly well suited to presentation in a dynamic layout environment. Generally stated, the rules 201 include instructions or guidance that enforce the following principles on elements being used in the construction of an ad.

First, the rules 201 provide that any text that is to be included in the ad must be vector-based. In other words, any text 212 that is to be included in an ad should be composed of vector-based fonts rather than raster-based fonts. Vector-based text has superior scaling characteristics and is not subject to tiling or other loss of fidelity due to changes in the size of the text. Accordingly, vector-based text is preferred by the rules 201.

Second, the rules 201 provide that any borders of the ad should be scalable without loss in fidelity. In other words, any area around the edge of the ad should be defined such that it will not suffer from disfigurement due to scaling or changes in aspect ratio. In one specific example, borders should be defined in terms of “remainder values,” meaning that the characteristics of a border should be specified with respect to that part of an ad that is outside of the other, core elements of the ad (i.e., the “remainder” of the ad). In another example, if an image or pattern is used to fill in a border, the image or pattern should be repeatable such that the image or pattern will look substantially the same regardless of how large the border is or what shape the border is in.

Third, the rules 201 require that logic for image swapping be incorporated into the ad. This rule is directed at controlling how an ad allows its constituent elements to be displayed in different layouts. For instance, an image being displayed at one size may not display well at a larger size. Accordingly, the ad layout 220 should include logic to swap the image to an alternative image if the size of the ad is enlarged over a certain threshold, which may be specified as an absolute value (e.g., in pixels) or as a relative value (e.g., as a percentage of the image's original size).

Additional rules 201 may also be included to help ensure that the resultant ad can grow or even alter its aspect ratio without significant loss in fidelity.

The system 200 further includes an authoring tool 230 that a developer can use to create a smart ad 231. Under control of a developer, the authoring tool 230 is used to combine by the various ad elements (e.g., the text 212, images 211, and code 213) based on specifications in an ad layout 220. The authoring tool 230 then combines those elements into a layout-aware ad 231 that is capable of having its size and/or shape altered without significant loss in fidelity. The resultant ad 231 differs from conventional ads that may be used in a dynamic layout environment in that, unlike conventional ads, the smart ad 231 does not degrade in appearance when being re-sized or when its aspect ratio is changed within certain parameters.

FIG. 3 is a graphical representation of one example of an ad 301 authored in accordance with layout rules, such as those introduced above in conjunction with FIG. 2. In this example, the ad 301 is based on an ad layout that defines the general characteristics of the ad 301. For example, a width 330 and height 331 of the ad 301 are specified in the ad layout. The width 330 and height 331 may be specified in terms of a preferred size or a range of appropriate sizes.

In addition, the ad 301 includes several elements that each include some media content. For example, a first element 311 may have certain associated text that may be displayed on the ad 301. The first element 311 may have different versions of the text, and logic that helps identify which version of the text to display based the current display characteristics, such as the display size. In addition, the text referred to by element 311 is composed of vector-based fonts for scalability without loss of fidelity.

Other elements, such as element 312 and element 313 are also included and refer to other media content. For example, element 312 may refer to one or more images that are to be displayed in the lower left corner of the ad 301. As with the text in element 311, element 312 may include logic to swap from one image to another based on the display characteristics of the ad 301. Element 313 may also include other media content. The respective positions of each element of the ad is specified in an ad layout. Accordingly, the aspect ratio of the ad 301 may be altered without skewing each element.

The ad 301 additionally includes a border 315, which is an area around the edge of the ad 301 in which no other elements reside. The border 315 provides a definable shape to the ad 301. In accordance with this embodiment, the border 315 is defined to display with characteristics that scale without loss in fidelity. For example, the border 315 may be a solid color that may grow or shrink without suffering from any adverse visual effects. Similarly, the border 315 may refer to a repeatable image or pattern that may grow or shrink without loss of fidelity.

The behavior of the elements within the ad 301 is based on the display characteristics of the ad 301. For example, the ad 301 may be presented at one aspect ratio under certain circumstances, such as while be displayed in conjunction with an article in a two column layout. As the display characteristics change, the elements may be rearranged within the ad 301 to improve the appearance of the ad 301 at its new aspect ratio. Unlike conventional advertisements, which would merely be skewed. Similarly, a change in size of the ad 301 may result in certain of the elements changing content, such as adding or removing text or swapping images, to accommodate the new size.

The principles and concepts presented above will now be described with reference to certain examples of ads in that may be displayed in conjunction with other content.

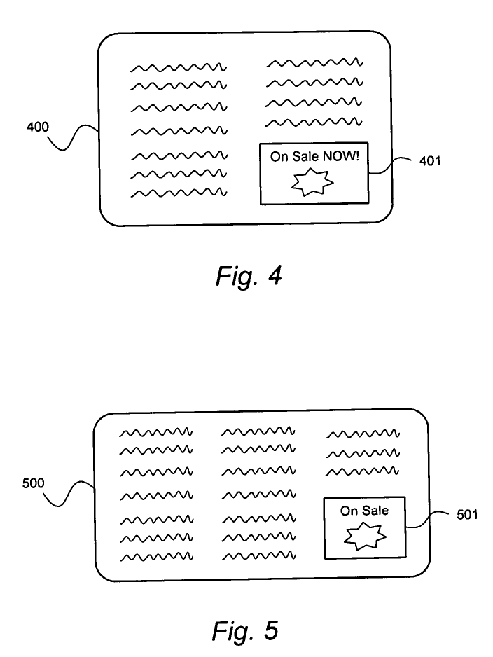

FIGS. 4 and 5 are graphical representations of a display 400 in which media content is being displayed. In this example, an article of text, such as a news article, is being rendered in the display 400 in a two-column layout. As laid out, the article does not consume the entirety of the two columns, and white space is left in the lower portion of the second column. In accordance with a dynamic layout environment, an ad 401 is displayed in the white space such that the display 400 appears finished.

Turning now to FIG. 5, as the display 400 is re-sized (display 500) the dynamic layout environment switches to a three-column layout, thus resulting in slightly different display characteristics. Thus, the ad 501 is slightly re-sized, resulting in a more narrow layout. In accordance with this embodiment, certain elements of the ad 501 alter their appearance to conform to the new display characteristics. More specifically, the text of the ad 501 is changed from “ON SALE NOW” to “ON SALE” so as to avoid reducing the font size or otherwise altering the ad 501.

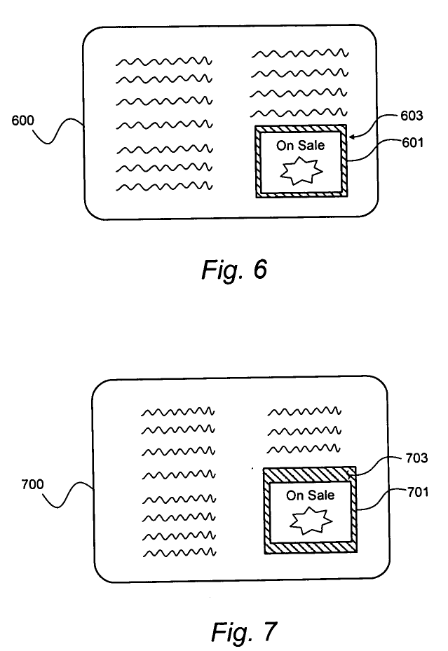

FIGS. 6 and 7 are graphical representations of another display 600 in which media content is being displayed. In this example, the article of text is again being displayed in a two-column format such that an ad 601 is being displayed in the white space below the article. The ad 601 includes a border 603 composed of a uniform color or the like.

The display 600 may be lengthened in the vertical direction, resulting in the new display 700, in which the white space below the article is slightly more tall but the same width as the ad 601 in display 600. In accordance with this implementation, the change in in aspect ratio is insufficient to alter the respective layouts of the ad elements, such as the text or image being displayed in the ad 701. However, in order to conform the ad 701 to the slightly larger white space, the border 703 is enlarged to expand into the larger space. Because the border 703 is designed to scale without loss of fidelity, the border continues to have the same finished appearance as its unaltered counterpart (ad 601).

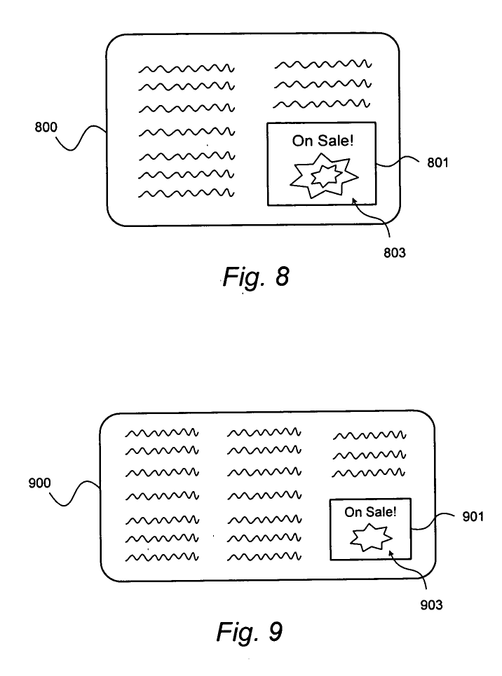

FIGS. 8 and 9 are graphical representations of yet another display 800 in which media content is being displayed. In this example again, the media content is being rendered in a two-column format, with an ad 801 in the lower right portion of the display 800. In this example, the ad 801 includes an image 803 at a particular current size and resolution.

As the display 800 is widened, such as by a user resizing a window, the media content switches to a three-column format (display 900). However, each of the three columns is significantly smaller than either of the original two columns of the two-column format (display 800), necessitating a significant re-size of the ad 901. In accordance with this implementation, logic incorporated in the ad 801, 901 detects that the original image 803 cannot be reduced in size sufficiently while avoiding a loss of fidelity or, perhaps meaning. Accordingly, the logic leads to a new image 903 being incorporated into the ad 901 in lieu of the original image 803. In this way, the re-sized ad 901 continues to look finished and appropriate in the new display characteristics 900.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention

We claim:

1. A computer-readable medium encoded with a data structure, comprising:
an electronic advertisement having an ad layout, the ad layout including at least one element that defines media content for the electronic advertisement, the element adhering to each of a plurality of rules, the rules comprising:
if the media content comprises text, the text is vector-based;
if the media content comprises a border, the border is scalable without loss of fidelity; and
if the media content comprises an image, the element includes logic for swapping the image based on a change in display characteristics of the electronic advertisement.

2. The computer-readable medium recited in claim 1, wherein the ad layout comprises a markup language document.

3. The computer-readable medium recited in claim 1, wherein the ad layout comprises computer-executable instructions.

4. The computer-readable medium recited in claim 1, wherein the border is defined in terms of an area outside of other elements in the electronic advertisement.

5. The computer-readable medium recited in claim 1, wherein the ad layout further comprises a plurality of elements, and wherein the ad layout further comprises logic that defines relative positions for each of the plurality of elements.

6. The computer-readable medium recited in claim 1, wherein the ad layout comprises a plurality of layers, each layer having an associated element, each layer being associated with a different set of display characteristics.

7. The computer-readable medium recited in claim 1, wherein the electronic advertisement comprises a plurality of elements, and wherein rendering the electronic advertisement under different display characteristics results in at least one element altering its display.

8. A computer-readable medium encoded with computer-executable components, comprising:
an ad authoring tool in operative communication with an image store, a text store, and a code store, the ad authoring tool being configured to construct an electronic advertisement based on an ad layout that defines elements of the electronic advertisement, each element referring to media content, the ad authoring tool being further configured to construct the electronic advertisement in a layered format with each layer being associated with a different range of display characteristics.

9. The computer-readable medium recited in claim 8, wherein at least one element includes text in vector format.

10. The computer-readable medium recited in claim 8, wherein at least one element defines a border for the electronic advertisement, the border being scalable without loss of fidelity.

11. The computer-readable medium recited in claim 8, wherein at least one element includes logic for swapping an image based on a change in display characteristics of the electronic advertisement.

12. A computer-readable medium encoded with computer-executable instructions, comprising:
authoring an electronic advertisement having an ad layout, the ad layout defining a plurality of ad elements, each ad element defining media content for the electronic advertisement, at least one element adhering to each of a plurality of rules, the rules comprising:
if the media content comprises text, the text is vector-based;
if the media content comprises a border, the border is scalable without loss of fidelity; and
if the media content comprises an image, the element includes logic for swapping the image based on a change in display characteristics of the electronic advertisement.

13. The computer-readable medium recited in claim 12, wherein the ad layout comprises a markup language document.

14. The computer-readable medium recited in claim 12, wherein the ad layout comprises computer-executable instructions.

15. The computer-readable medium recited in claim 12, wherein the border is defined in terms of an area outside of other elements in the electronic advertisement.

16. The computer-readable medium recited in claim 12, wherein the ad layout further comprises a plurality of elements, and wherein the ad layout further comprises logic that defines relative positions for each of the plurality of elements.

17. The computer-readable medium recited in claim 12, wherein the ad layout comprises a plurality of layers, each layer having an associated element, each layer being associated with a different set of display characteristics.

18. The computer-readable medium recited in claim 12, wherein the electronic advertisement comprises a plurality of elements, and wherein rendering the electronic advertisement under different display characteristics results in at least one element altering its display.
